(19) United States
(12) Patent Application Publication
(10) Pub. No.: US 2005/0158047 A1
(43) Pub. Date: Jul. 21, 2005

(54) Optical ring networks with failure protection mechanisms

(76) Inventors: Winston I. Way, Irvine, CA (US); Xin Jiang, Irvine, CA (US); Cedric Lam, Irvine, CA (US)

Correspondence Address: FISH & RICHARDSON, PC, 12390 EL CAMINO REAL, SAN DIEGO, CA, 92130-2081, US

(21) Appl. No.: 10/893,750

(22) Filed: Jul. 16, 2004

Related U.S. Application Data
(60) Provisional application No. 60/488,173, filed on Jul. 16, 2003.

(51) Int. Cl. H04B 10/20

(52) U.S. Cl. 398/59

(57) ABSTRACT

This application describes, among others, fiber ring networks with two fiber rings to provide local fiber failure protection in each node and capability for each node to broadcast to other nodes, and to establish uni-directional and bi-directional communications with one or more selected nodes. Each optical channel may have a single optical break point in the ring networks and this single optical break point is located in a designated node. Various application may advantageously use such ring networks such as ring networks with asymmetric traffic like video-on-demand systems and other information systems.

This application claims the benefit of U.S. Provisional Patent Application No. 60/488,173 entitled “Optical Ring. Networks With Failure Protection Mechanisms” and filed Jul. 16, 2003, the entire disclosure of which is incorporated herein by reference as part of the specification of this application.

### BACKGROUND

This application relates to optical communications based on wavelength division multiplexing, and more particularly, to optical networks in ring configurations and associated fault management and failure protection techniques.

Fiber optical communication systems may be implemented in a variety of network configurations. Fiber ring networks represent one type of network configurations and have versatile applications for, e.g., forming the access part of a network or the backbone of a network such as interconnecting central offices. Fiber ring networks may include more than one fiber rings to connect communication nodes and hubs to provide redundancy and to ensure continuity of communications when one of the fiber rings fails. Different communication protocols and standards may be used in ring networks, such as the Synchronous Optical Network (SONET) standard.

### SUMMARY

This application includes fiber ring networks and techniques for using two fiber rings to provide communication redundancy and failure protection with local detection and switching control in each communication node. Optical channel designation among the communication nodes is provided to allow for a communication node to broadcast an signal to the ring networks and to establish either or both of unidirectional and bidirectional communications with other nodes.

One example of an optical ring network system is described to include communication nodes, and first and second fiber rings. The first fiber ring is coupled to the communication nodes to direct WDM optical signals at different wavelengths. The second fiber ring is coupled to the same communication nodes to direct duplication of the WDM optical signals. Each communication node that sends a signal is operable to add and drop at least one pre-selected WDM optical signal in both the first and second fiber rings without an optical-break point in other communication nodes. This communication node further allows for other WDM optical signals to get dropped and to continue to a next communication node without changing information therein. Each communication node comprises an optical-receiver, an optical switch to direct light from the first fiber ring into the optical receiver, and a switch control which monitors light received by the optical receiver and control the optical switch to direct light from the second fiber ring to the optical receiver when a signal property in light from said first fiber ring fails to meet a threshold.

In another example of an optical ring network system, a first fiber ring is coupled to communication nodes to direct WDM optical signals at different wavelengths along a first direction. A second fiber ring is coupled to the same communication nodes to direct duplication of said WDM optical signals along a second direction opposite to the first direction. Among the communication nodes, a first communication node is operable to add and drop a first WDM optical signal in both the first and second fiber rings, and the first communication node further allows for other WDM optical signals to get dropped and to continue to a next communication node without changing information therein. Also, a second communication node adds and drops a second WDM optical signal in both the first and second fiber rings, and the second communication node further allows for other WDM optical signals to get dropped and to continue to a next communication node without changing information therein. Each of other communication nodes allows for the first and the second WDM optical signals to get dropped and to continue to a next communication node without changing information therein.

This application also describes methods for operating fiber ring networks. In one implementation, for example, first and second fiber rings are provided to be optically coupled to a plurality of communication nodes. Each optical signal from a communication node is then coupled to both the first and the second fiber rings. A single communication node is used to originate and terminate one or more pre-selected optical channels in the first and the second fiber rings without having an optical break point in the one or more pre-selected optical channels in other communication nodes, and to pass through other optical channels without changing information therein. An optical receiver within each communication node is used to monitor a signal quality in light from the first fiber ring via an optical switch within the communication node to receive light from both the first and the second fiber rings. The optical switch is controlled to direct light from the second fiber ring into the optical receiver when the signal quality from the first fiber ring fails to meet a threshold.

These and other fiber ring networks and their operations and benefits are described in greater detail in the attached drawings, the detailed description, and the claims.

### BRIEF DESCRIPTION OF DRAWINGS

FIG. 1 shows an example of a dual fiber ring network where each node has a local detection and switch mechanism to maintain normal optical transmission in case of a single fiber failure.

FIG. 2 shows an example of a dual fiber ring network designed to have a single optical break point in each optical channel at a designated node to allow for each node to send information to the ring network.

FIG. 3 shows an exemplary application of the design in FIG. 2.

FIGS. 4, 5, 6, and 7 illustrates examples of different node designs suitable for the application in FIG. 3.

FIG. 8 shows another exemplary application of the design in FIG. 2.

FIG. 9 shows one example of a node design for use in FIG. 8.

FIG. 10 shows a third exemplary application of the design in FIG. 2, where two or more different channels within one band are allocated to different nodes.

FIG. 11 shows an example of a node suitable for the ring network in FIG. 10.

FIG. 12 shows a fourth example of a dual fiber ring network where two nodes are allocated with two subbands within the same band, respectively.

FIGS. 13, 14, and 15 show examples of nodes for the ring network in FIG. 12.

FIG. 16 shows one implementation of the local detection and local switch control within each node connected in a dual fiber ring network shown in FIG. 1.

FIG. 17 shows another implementation of the local detection with a single hi-speed optical detector.

FIG. 18 shows a video-on-demand system with a dual fiber ring network based on this application as an example of an asymmetric traffic dual ring network.

### DETAILED DESCRIPTION

Optical networks with a ring configuration described in this application may be used in various communication systems, e.g., access networks, backbone networks, and other networks. Cable television systems, video-on-demand delivery systems, and other communication service systems may use fiber rings described here. In the present ring networks, optical communication signals circulate in a ring and two or more communication nodes are connected in the optical ring to send out or receive communication signals in the ring. An output optical signal from a node may be a broadcast signal to all nodes in the ring, a multicast signal to selected nodes in the ring, or a signal to a selected single node. The ring may be designed to support a unidirectional signal which circulates along one direction in the ring. Bi-directional communications between two or more selected nodes may also be supported in the ring as described below. In addition, the ring networks of this application may be implemented in various configurations, such as centrally controlled networks with a central office and dispersed hubs, and distributed networks with hubs or nodes that have distributed traffic, control or management.

In the specific exemplary ring networks described here, each ring network has a dual fiber ring configuration where two separate fiber rings are used to connect all nodes and to carry optical signals in opposite directions, respectively. A node in such ring networks, when sending out a communication signal, simultaneously produces two optical signals carrying the signal in opposite directions in the two separate fiber rings. Similar to other dual ring networks, this use of the dual fiber rings in the ring networks of this application provides a redundancy for each communication signal and allows the ring to continue to operate when there is a fiber break on the ring. Different from other dual ring networks, the ring networks of this application provide unique features within nodes to allow for broadcast and select communications and node-to-node uni-directional and bi-directional communications along with enhanced failure protection mechanisms.

Ring networks described here may use wavelength division multiplexing (WDM) or ultra dense WDM to transmit multiple optical signals at different wavelengths in a single fiber. These wavelengths may be at different ITU-specified WDM wavelengths and each ITU wavelength is generally assigned to a single optical channel. All optical signals at different wavelengths may be divided into bands for purpose of communication management as described here, where each band may include one or more optical signals at different wavelengths. These bands and ITU channels may be dropped or added at each node. Tunable or fixed narrow passband optical filters or WDM demultiplexers may be used to separate the ITU channels within each band.

In addition, multiple wavelengths for different channels may be closely packed within each ITU grid to increase the number of WDM channels beyond the common arrangement of one channel per ITU grid. Accordingly, high resolution tunable or fixed narrow passband optical filters or WDM demultiplexers may be used to separate the closely spaced channel wavelengths within each ITU grid. One way to generate such closely spaced wavelengths within each ITU grid, as an example, is to use subcarrier multiplexing by interleaving subcarrier-sidebands and suppressing optical carrier from multiple separately modulated subcarriers. Exemplary methods include use of an optical single sideband modulation to obtain the components within the one ITU wavelength grid as described in U.S. Pat. No. 6,525,857 entitled “Method Apparatus for Interleaved Optical Single Sideband Modulation” and issued on Feb. 25, 2003 to Way et al., the entire disclosure of which is incorporated herein by reference as part of the specification of this application.

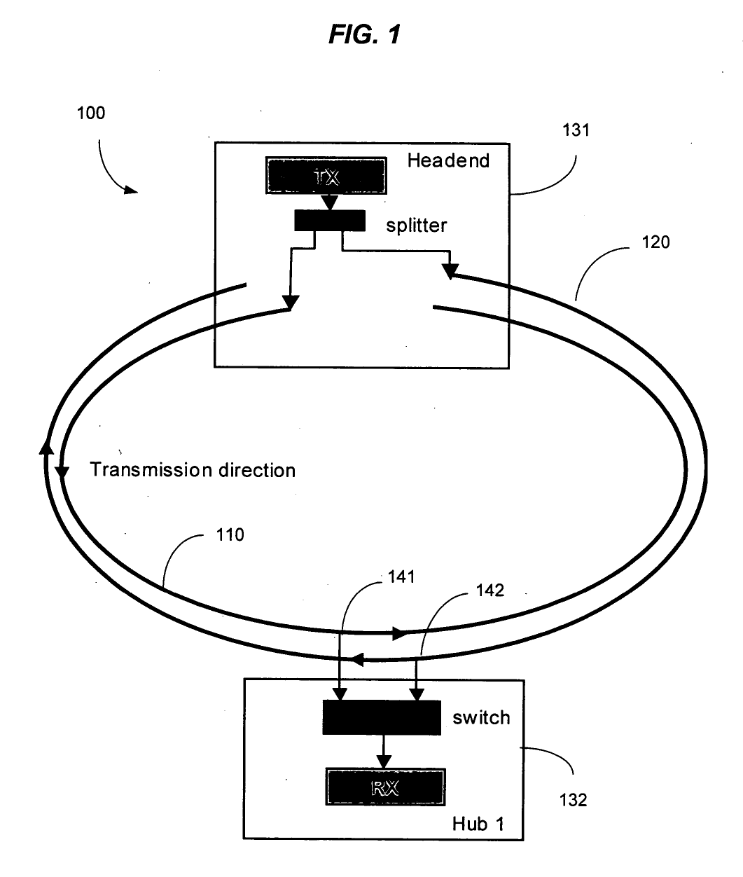

FIG. 1 illustrates an exemplary dual fiber ring network 100 with a first fiber ring 110 and a second fiber ring 120. Two nodes 131 and 132 are shown to be connected in the ring network 100 as examples. The node 131 is shown as a headend node that may be implemented in a CATV optical fiber network. The node 132 is shown as a hub that receives the signals from the headend node 131. Other nodes, such as additional hubs similar to the node 132, may be connected in the ring network 100.

The headend node 131 has an optical transmitter (TX) to produce an optical signal and an optical splitter which splits the optical signal into a first optical signal to be coupled to the first fiber ring 110 in the counter-clock-wise direction and a second optical signal to be coupled to the second fiber ring 120 in the clock-wise direction. In the hub 132, an optical switch is coupled to receive signals from both fiber rings 110 and 120 and is switched to direct only one received signal from one of the two fiber rings 110 and 120 to an optical receiver (RX) during normal operation. When the received signal from the fiber ring is degraded beyond a preset threshold level or is lost, the switch responds by a switching action to direct the same optical signal from the other fiber ring to the receiver instead. Hence, this protection switching mechanism, called optical uni-directional path switching (O-UPSR) or tail-end switching, maintains the optical communication in the ring network 100 when there is a single fiber break point on the ring network 100. Since the switching action is based on the signal that is detected by the optical receiver (RX) local (in the same node) to the switch, fast protection switch, as fast as less than about 50 ms, can be achieved.

Each node 132 may use two optical devices 141 and 142 to respectively couple in the fiber rings 110 and 120 to drop signals from and add its allocated channel to the ring network 100. In general, such optical devices 141 and 142 may be implemented with broadband or narrowband couplers, or a band optical add-drop filter (BOAD) which adds or drops one or more selected channels within a band. Within the receiver (RX) in the hub 131, a WDM demultiplexer or a tunable bandpass optical filter may be used to select the desired one or more channels from a signal received from the fiber ring 110 or 120. Hence, this ring network 100 is a broadcast and select ring where the broadcast feature is reflected by the fact that each signal sent to the ring network 100 by a node, e.g., the node 131 as illustrated, can be received by any node connected to the network 100, and where the select feature is reflected by the ability of each node, such as the node 132, for selectively receiving one or more desired channels (e.g., one or more selected bands).

Notably, the exemplary ring network 100 implements nodes 131, 132, etc. that allow for each individual channel or a band of channels in each of the fiber rings 110 and 120 to have only one break point in the optical propagation of the channel or a band of channels through out each of the two rings 110 and 120. This single break point is located within a designated node for each individual channel or a band of channels inside the fiber ring 110 or 120. The designated node for the above channel or a band of channels may include one or more optical transmitters as part of the break point and send out information in that channel or a band of channels to the fiber rings 110 and 120. The break point eliminates the possibility of optical signal crosstalk and undesired optical oscillation in the ring if optical amplifiers are implemented within the ring. Under this single-break-point design, the channel or a band of channels which has an optical break point in its designated node passes through any other nodes in the ring network 100 without an optical break point. Certainly, other nodes may either split a portion of all optical signals in each of two fiber rings 110 and 120 including the above channel or band channels, or selectively split one or more selected channels from each fiber ring without interrupting the continuous propagation of the above channel or band channels. In this context, the channel or a band of channels is said to be allocated to the designated node for sending out information to the fiber ring network 100.

In some implementations of the above single-break-point design, each node may be allocated with one channel or band channel. But two or more channels or band channels may also be allocated to a particular node in order to increase the capacity of that particular node for sending out information to the ring network 100. One example of such a node is a headend node in a CATV system for delivering various programming channels to users connected to the CATV system, such as a video-on-demand (VOD) channel to one or more users who requested a particular video program.

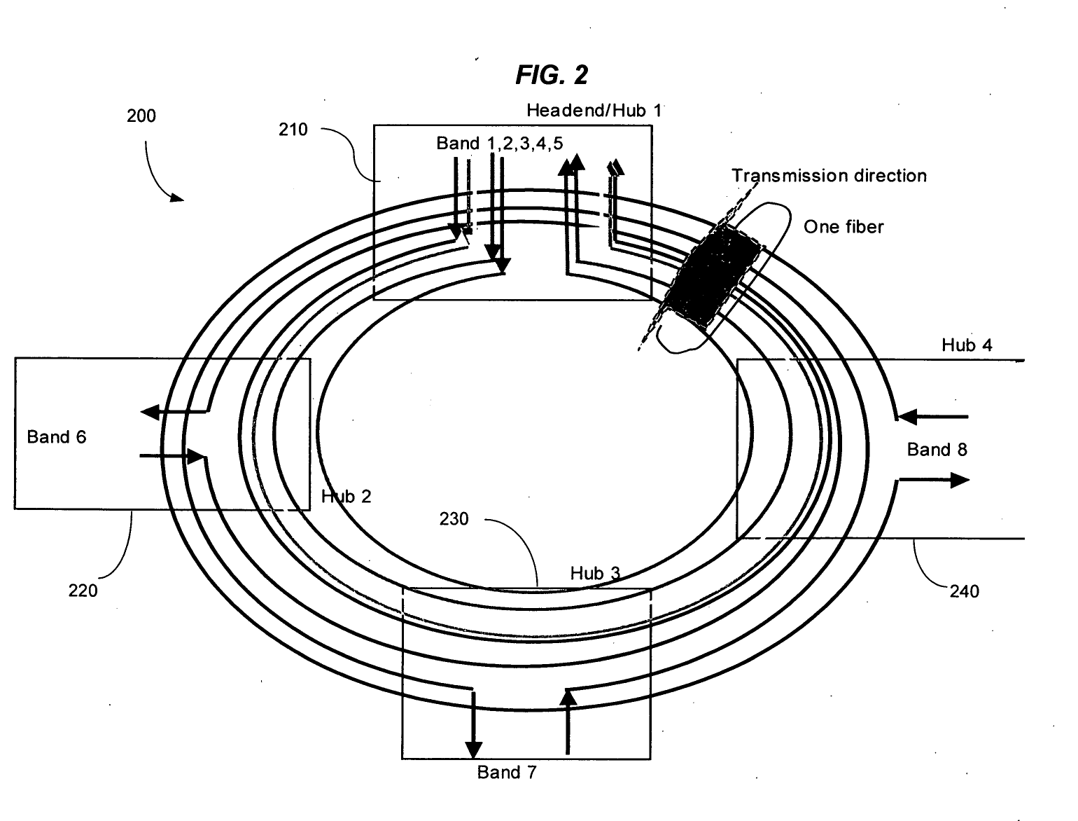

FIG. 2 shows a few bands of channels in the counter-clock-wise fiber ring of an exemplary 4-node WDM dual fiber ring network 200 to illustrate the above allocation of a channel or a band of channels in the single-break-point design. Note that channels and channel allocation of the nodes in the other clock-wise fiber ring of the network 200 are essentially identical and thus are omitted here for simplicity. It can be seen that, for each channel or a band of channels, the only break point on the ring network is its originating point.

This exemplary network 200 is shown to include four different nodes or hubs 210, 220, 230, and 240 in each of the two fiber rings. In general, different nodes may have either the same or different designs depending on specific requirements of the application of the network 200. In this particular example, the node or hub 210 is similar to a headend node in a CATV system in the sense that it is allocated a largest number of bands of channels where each of the other three nodes 220, 230, and 240 is allocated with a single band channel. It is assumed here that, as an example, the network 200 has a total of eight available WDM bands at different wavelengths, each band may include one or more wavelengths for carrying data channels. The node 210 is allocated with five bands 1, 2, 3, 4, and 5. Each of its allocated bands has a continuous optical path through the entire ring except a single optical break point within the node 210 which originates and also terminates bands 1, 2, 3, 4, and 5. The nodes 220, 230, and 240 are allocated with bands 6, 7, and 8, respectively. Hence, the band 6 originates from and ends at the node 220 and has a continuous optical path throughout the rest of the ring; the band 7 originates from and ends at the node 230 and has a continuous optical path throughout the rest of the ring; and the band 8 originates from and ends at the node 240 and has a continuous optical path throughout the rest of the ring.

Under the above channel allocation scheme, each node can broadcast information to any other node with a fast protection from a single failure point on the ring network. In addition, each node can receive information sent by any other node with fast fiber failure protection. Therefore, any two nodes in the ring network can send information to each other with fast fiber failure protection which restores communication in a short response time, e.g., less than about 50 ms. This two-way communication between any two nodes is bi-directional and uses the two allocated bands for the two nodes. For example, the node 220 and node 240 communicate with each other using their allocated bands 6 and 8, respectively. The node 210 can use any of its allocated bands 1-5 to communicate with another node in the broadcast and select optical network 200.

Hence, a dual fiber ring network based on the above design allocates at least one channel or band to each node in the network that passes through all other nodes without an optical break point to allow each node to send out information in its allocated channel or band and to communicate with another node (bi-directional) or to broadcast information to all nodes on the network (uni-directional). The remaining channels or bands can then be assigned to one or more nodes according to the communication requirements of the network. Certainly, under certain application conditions, one or more nodes in the network may be passive receivers and hence are not allocated with a channel or band for sending out information to the network. All channels or bands drop and continue through such a passive node without an optical break point.

In implementing a bi-directional communication between two nodes, each node may use its designated channel or band to send information to the other node so that the bi-direction communication is established with two separate channels respectively designated to the two communicating nodes. For example, the nodes 220 and 240 in FIG. 2 may communicate with each other by having the node 220 to use a designated channel in the designated band 6 to send information to the node 240 and the node 240 to use a designated channel in the designated band 8 to send information to the node 220. The wavelength of the signal sent by the node 220 to the node 240 indicates the node 240 as the destination so other nodes may ignore the signal. The information sent by a user in the node 220 to another user in the node 240 may be encrypted by another wavelength so only the intended user can extract the information from the optical signal in the band 6 broadcasted to the ring network 200. Therefore, assuming each band in FIG. 2 includes multiple band channels, each node may use one band channel in its designated band to establish a bi-directional communication with another node and use other band channels to either broadcast information to all nodes in the ring network 200 or communicate with selected nodes in either a bi-directional mode or in a uni-directional mode. Accordingly, one portion of available optical wavelengths in such a fiber ring network may be allocated for carrying uni-directional communication traffic and another portion of the available optical wavelengths may be allocated for carrying bi-directional communication traffic. For one communication node designated with multiple channels within the designated band, some channels within the band may be used for bidirectional communication with other nodes and some channels may be used for unidirectional communication with some other nodes or all nodes (broadcast).

Based on the above exemplary architectural designs, specific implementations of dual fiber ring networks and their nodes are now described in the following.

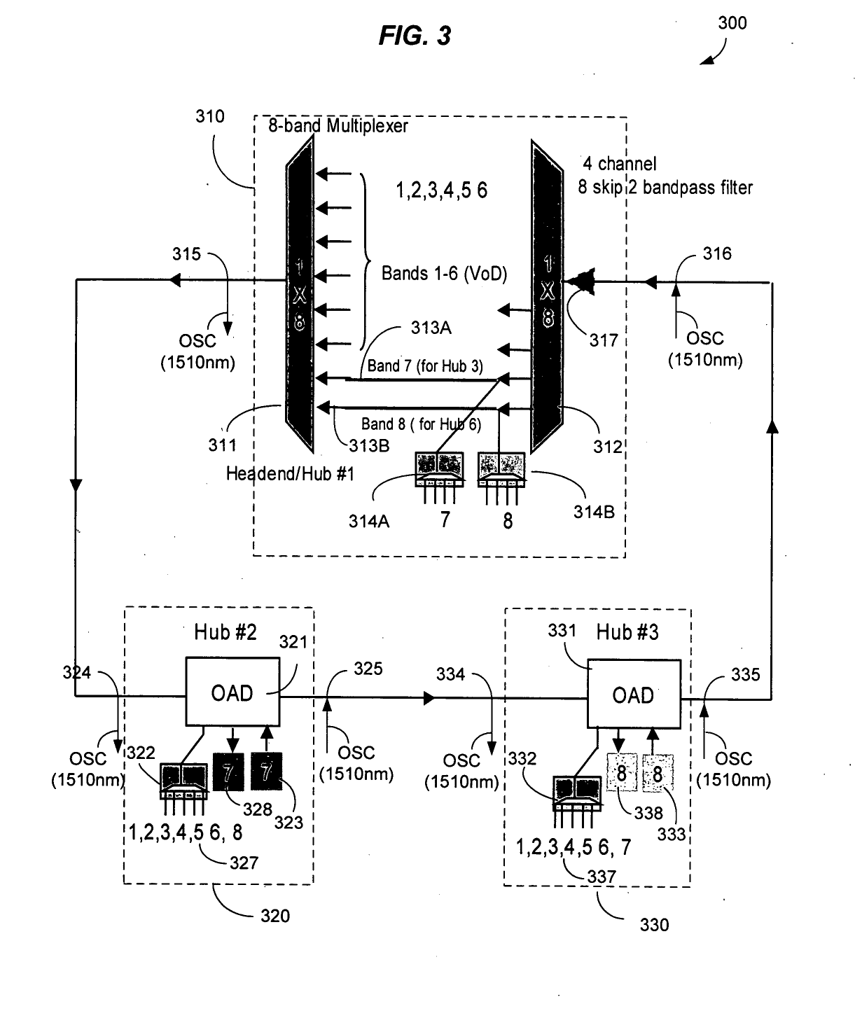

FIG. 3 illustrates a first example of a dual fiber ring network 300 where a node 310 is allocated with six of eight available bands and nodes 320 and 330 are allocated with bands 7 and 8, respectively. In this example, only the counter-clock-wise fiber ring is shown. The clock-wise fiber ring is substantially identical to the counter-clock-wise fiber ring and thus is omitted for simplicity. The node 310 may include a first 1×8 WDM band multiplexer 311 as the output terminal to the ring network 300 and a second 1×8 WDM band demultiplexer 312 to separate received WDM signals from the ring network 300. Two optical bypass paths 313A and 313B are formed between the ports of the devices 311 and 312 to allow the separated bands 7 and 8 allocated to nodes 320 and 330 to pass through. A fraction of each of the bands 7 and 8 is split off by using, e.g., an optical coupler or splitter or an optical add/drop multiplexer, to download to the node 310. Each band may be a single ITU grid channel or may include two or more ITU grid channels. If subcarrier sidebands are used, each of the bands 7 and 8 may be a single subcarrier sideband or two or more subcarrier sidebands within one ITU grid. When each band has more than one channel, devices 314A and 314B may be used to separate the wavelengths of different channels, either ITU grid channels or subcarier sideband channels, prior to detection of the channels. The devices 314A and 314B may be implemented to include a WDM demultiplexer, a tunable filter, or a bank of fixed filters, for example. One or more optical amplifiers 317 may be connected in each fiber ring to amplify the optical signals therein for power compensation.

The nodes 320 and 330 may be configured differently from the node 310. For example, the node 320 may use an optical add and drop device 321, which may be a combination of an optical splitter, an add/drop filter, or an add/drop multiplexer (mux) and demultiplexer (demux) to split a fraction of the bands 1-6 and 8 and drop the band 7 that is allocated to the node 320. In one implementation, for example, the device 321 may include optical amplifiers to compensate for power loss due to the transmission and power splitting. An optical device 322 may be used to receive the optical drop signal and to separate channels in bands 1-6 and 8 to a bank 327 of optical detectors. An optical transmitter 323 may be used to produce the output signal in band 7, via an optical coupler or an optical add and drop device (OAD), with the desired information from the node 320. The device 322 may include an optical splitter, a WDM demux, a tunable filter, or a bank of fixed filters to separate the channels in bands 1-6 and 8 prior to detection of selected one or more channels. An optical detector 328 may be implemented to receive the dropped band 7.

The node 330 may have a similar design as the node 320 and include a device 331 to split a fraction of the bands 1-7 and drop the band 8 that is allocated to the node 330 and is to be received by a detector 338, a device 332 to separate bands 1-7 into a bank of detectors 337 and an optical transmitter 333 to produce the output channel in band 8 with the desired information from the node 330.

The channels 1-8 for data communications may use the 1550-nm C band while optical supervision channels (OSCs) may use wavelengths outside the C-band, e.g., 1510 nm or 1620 nm. As illustrated, at the two ends of node 310, WDM couplers 315 and 316 are used to inject and retrieve the OSCs from the fiber ring. Similarly, WDM couplers 324 and 325 are coupled at the two ends of the node 320 and WDM couplers 334 and 335 are coupled at the two ends of the node 330 for coupling the OSC signals.

One of the applications of the network 300 in FIG. 3 is for a CATV system that delivers television programs from the node 310 as the headend to users connected at the nodes 320 and 330 as the hubs. VOD signals may be delivered to the users via channels in bands 1-6 while the user commands and requests may be carried by the channels in bands 7 and 8. Certainly, nodes 2 and 3 may communicate with each other by using channels in bands 7 and 8.

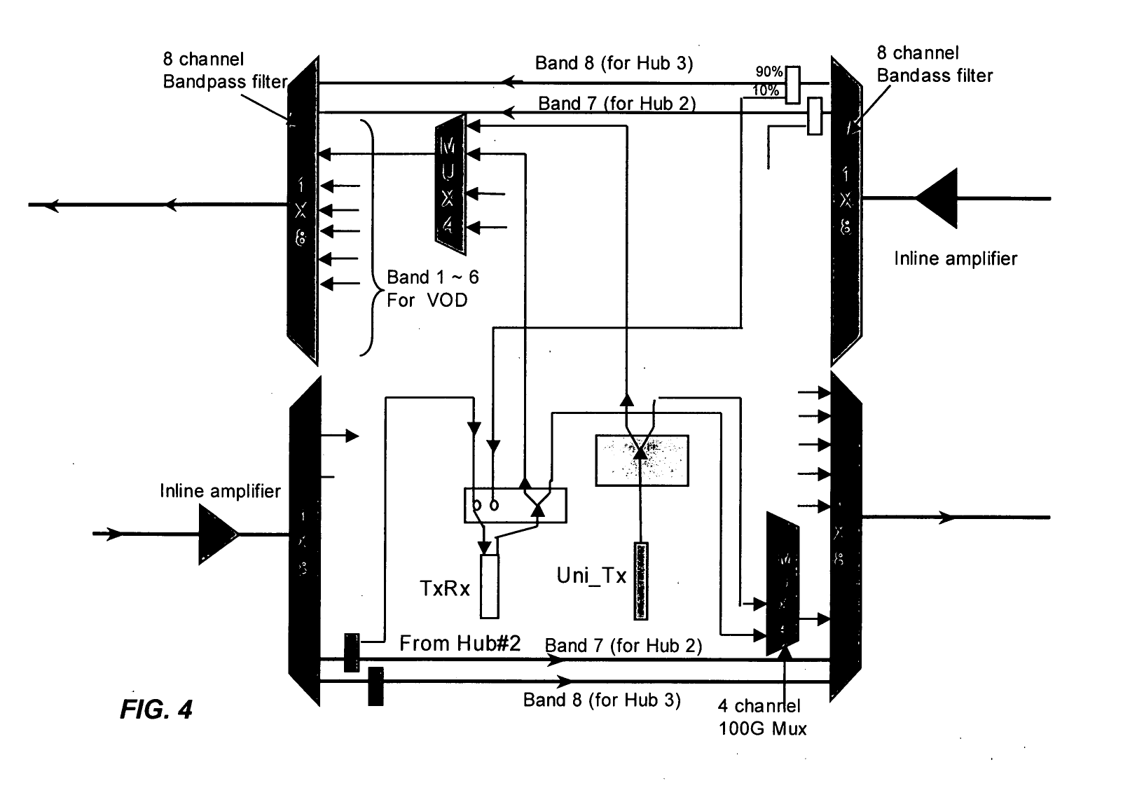

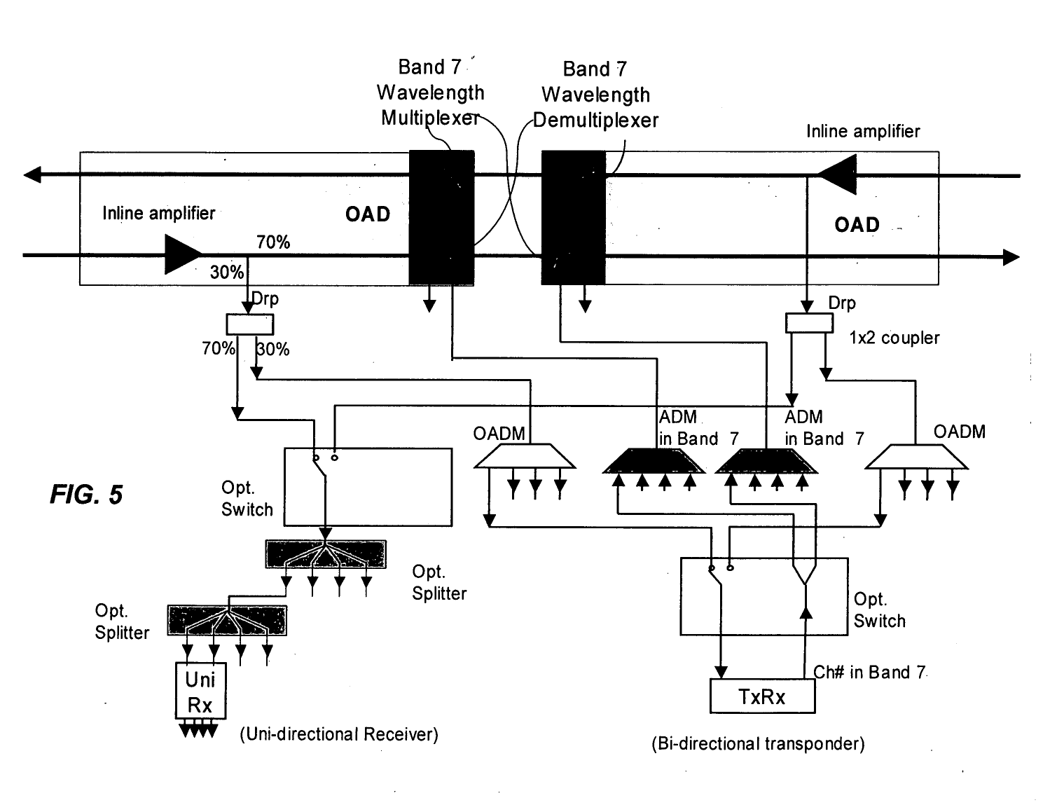

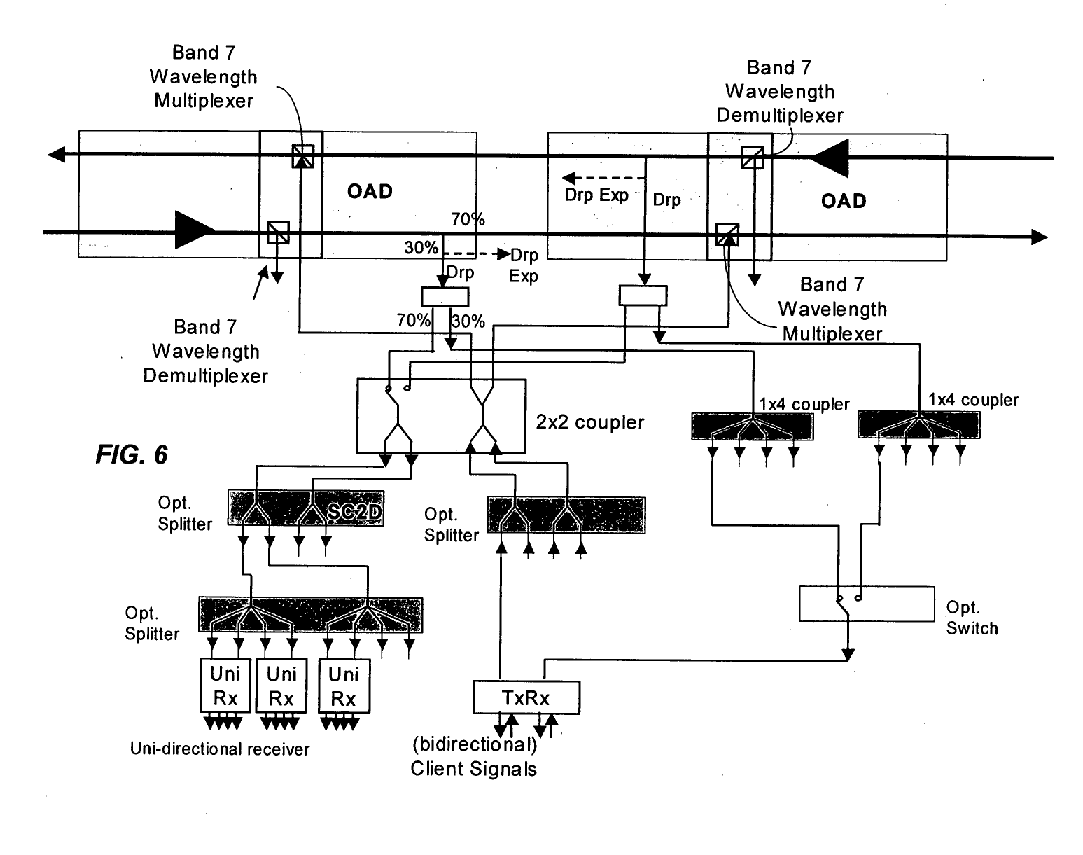

FIG. 4 shows one exemplary implementation of the node 310 in FIG. 3 with optical amplifiers for the communication channels at the 1550-nm band in both directions. FIGS. 5 and 6 show two different implementations of the node 320 by using an optical coupler to split a fraction of the bands 1-6 and 8 for dropping and adding only the allocated channels in band 7 without affecting other channels in bands 1-6 and 8. FIGS. 5 and 6 are different from each other in the relative positions of the optical coupler in one aspect. In FIG. 5, the optical coupler is used to split a fraction of power of all received channels, including its allocated band 7 and then the dropping-band optical add and drop multiplexer (ADM) for the band 7 is used to drop the channels in band 7. In FIG. 6, the band ADM is used first to drop off the band 7 and then the optical coupler is used to split a fraction of the channels in bands 1-6 and 8. In addition, FIGS. 5 and 6 are different from each other in the subsequent processing elements in the nodes. In FIG. 5, multiplexers and demultiplexers are extensively used to splitting and combining different channels. In FIG. 6, less expansive optical couplers are used to replace certain multiplexers/demultiplexers to reduce the cost. A 2×2 coupler in FIG. 6 is used to reduce the optical loss and the cost. It may be beneficial to mix the use of multiplexers/demultiplexers with couplers under different conditions. Each demultiplexer may be replaced by a bank of tunable or fixed optical filters. The optical splitter for dropping signals in each fiber line into the node and the optical 1×2 splitter for splitting the dropped signal are shown to have 70/30 power splitting as an example only.

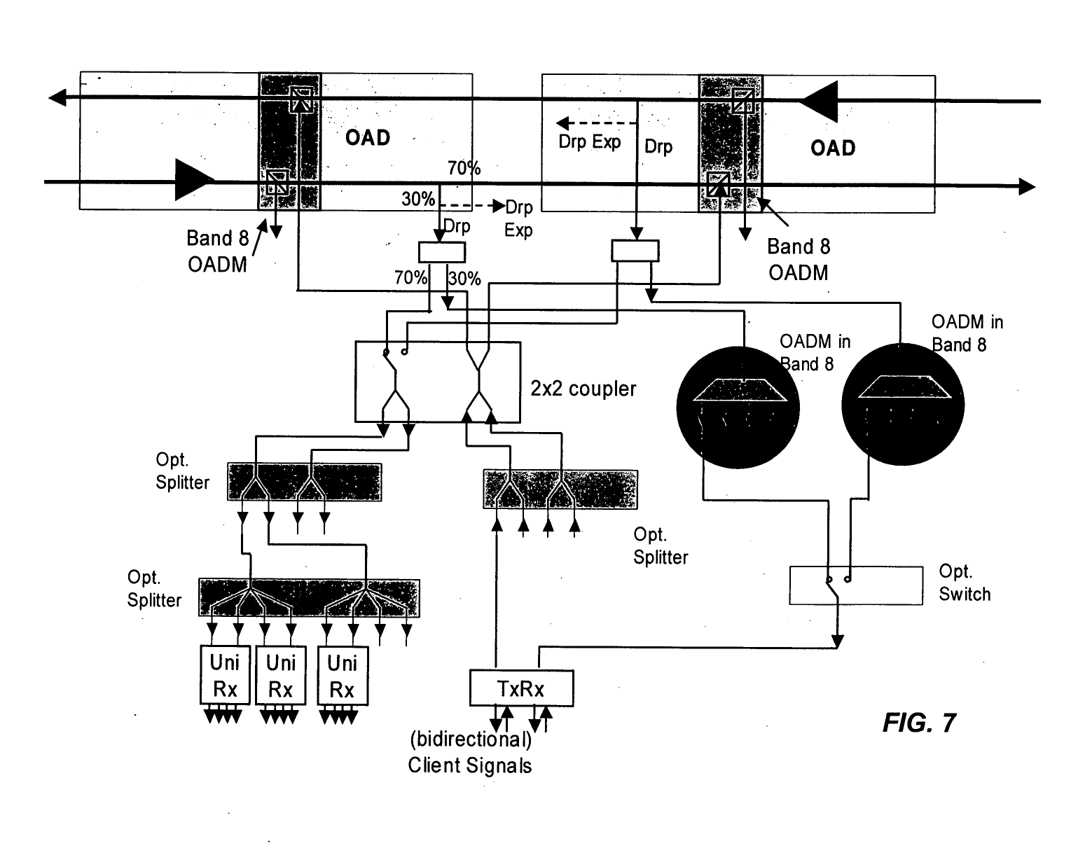

FIG. 7 shows one exemplary implementation of the node 330 in FIG. 3 that is similar to the node design shown in FIG. 6 in some aspects. The node design in FIG. 5 may also be used for the node 330.

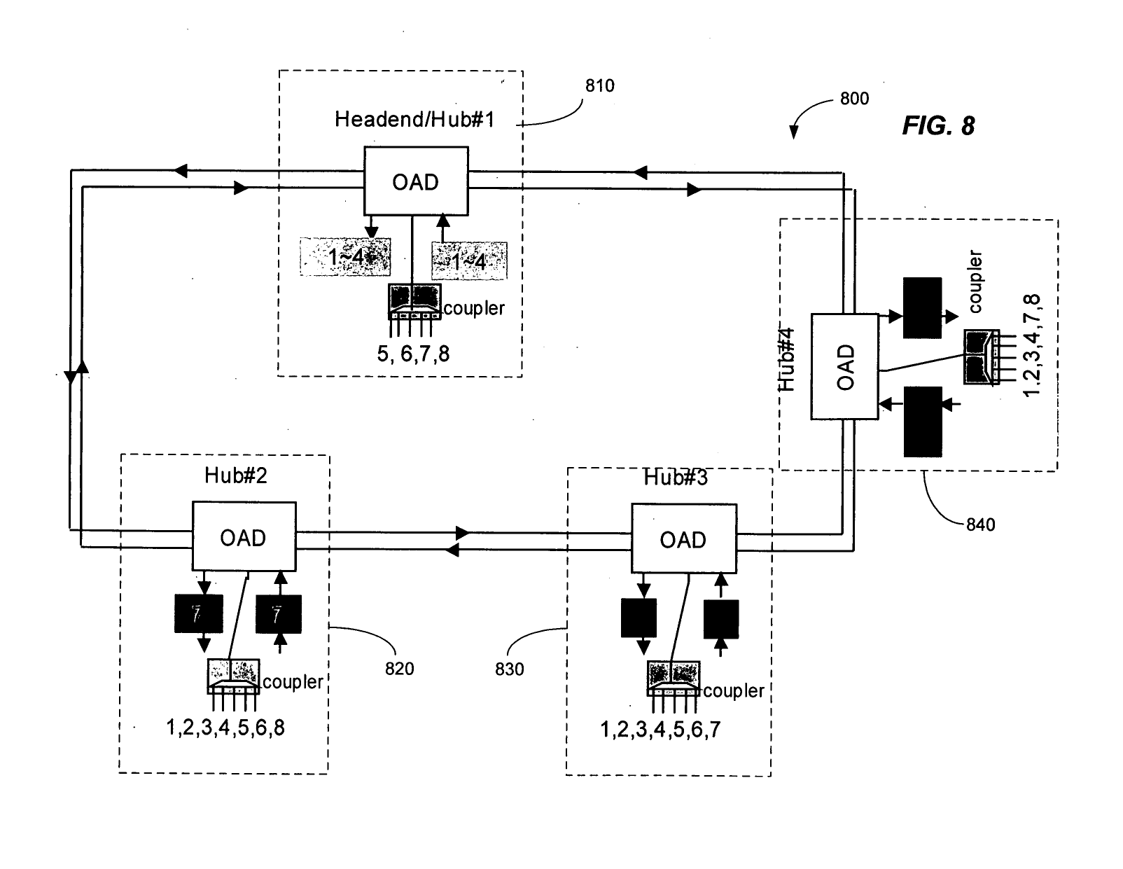

FIG. 8 illustrates a second example of a dual fiber ring network 800 where nodes 810, 820, 830, and 840 all use combinations of optical couplers and BOADs (within each BOAD box) without WDM mux and dmux devices. The node 810 is allocated with bands 1-4 of eight available signal bands, the node 840 is allocated with bands 5 and 6, while nodes 820 and 830 are respectively allocated with bands 7 and 8. Each hub (including the headend) is shown to use a 1×N coupler or demultiplexer to receive all optical signals in the ring from other hubs. Each hub may also use a band optical add and drop device (BOAD) to add its local traffic onto the ring network, and uses the other BOAD to drop its added traffic after circling around the ring once. Note that the BOAD can also be replaced by a channel OAD for a single wavelength when there are multiple hubs to share a limited number of wavelengths.

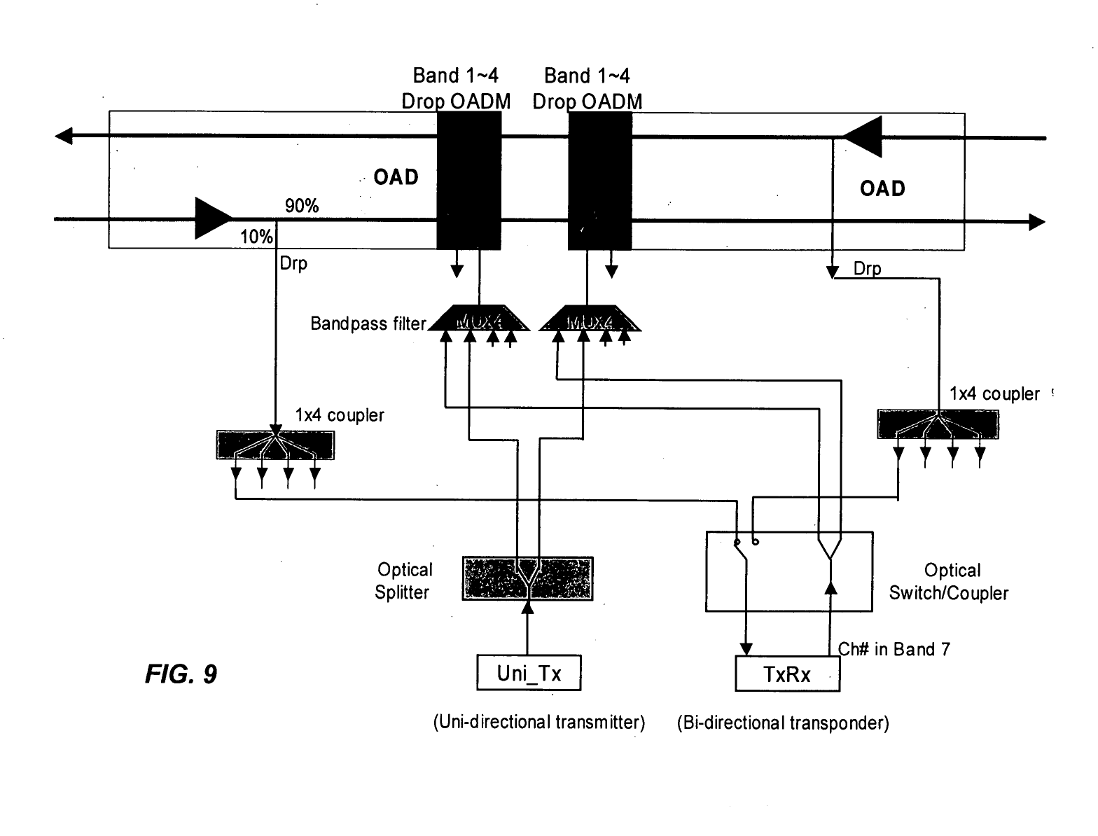

FIG. 9 shows one implementation of the node 810 where optical couplers are used to drop all channels from both fiber rings and BOADs are used to add and drop the allocated bands 1-4. Nodes 820 and 830 may use the designs for the nodes 320 and 330. Node 840 with two allocated bands 5 and 6 may use a modified version of the node design in FIG. 9 where a 1×4 device is replaced by a 1×2 device.

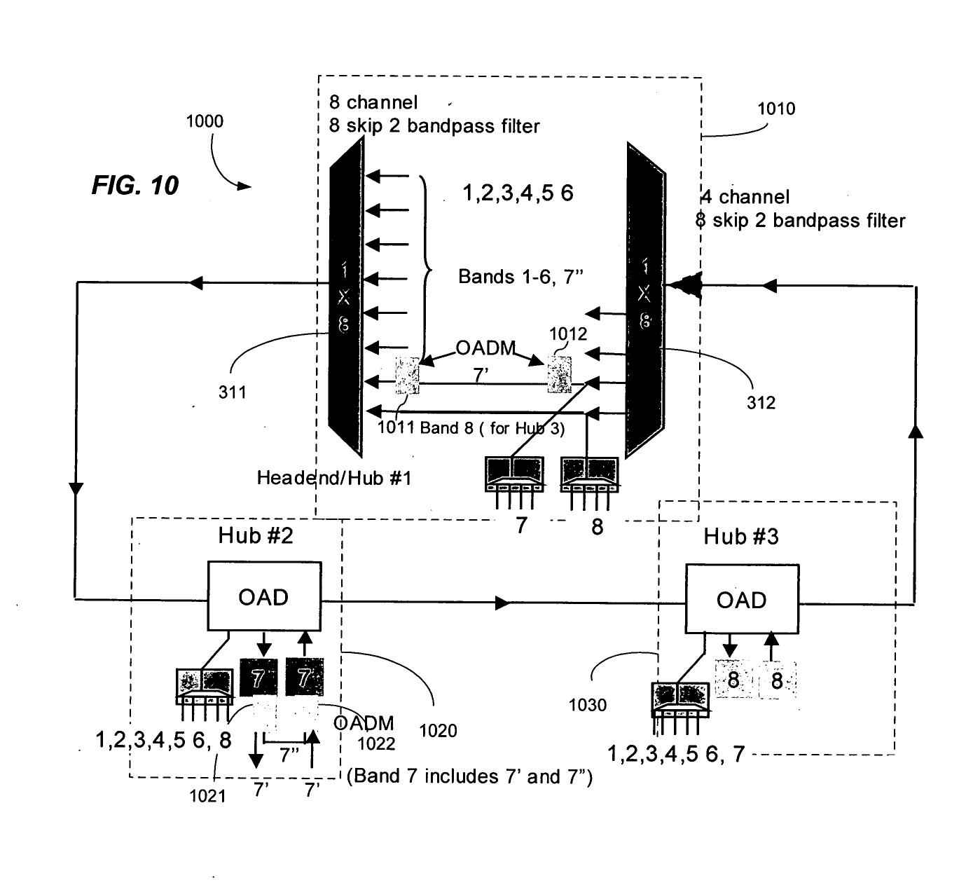

Referring now to FIG. 10, a third example of a dual fiber ring network 1000 is illustrated to have a mechanism for allocating a part of a band, e.g., a channel 7′ within a band 7, that is dropped at a node 1020 while another channel 7″ within the band 7 is allocated to the node 1010. The ring network 1000 uses a modified node design shown in FIGS. 3 and 4 for the node 1010 by adding an optical ADM 1012 to receive the band 7 from the WDM demux 312 and to separate the channels 7′ and 7″ within the band 7. An optical bypass is provided in the node 1010 for the channel 7′ to pass through. In addition, an optical ADM 1011 is used to combine the passing-through channel 7′ and the newly-produced channel 7″ into the output band 7. Like in the system 300 in FIG. 3, a second bypass path is provided to allow the band 8 to pass through since the band 8 is allocated to another node 1030. The node 1020 may be implemented by modifying the node designs in FIGS. 5 and 6 where ADMs 1021 and 1022 are added to allow the band channel 7″ to bypass the node 1020.

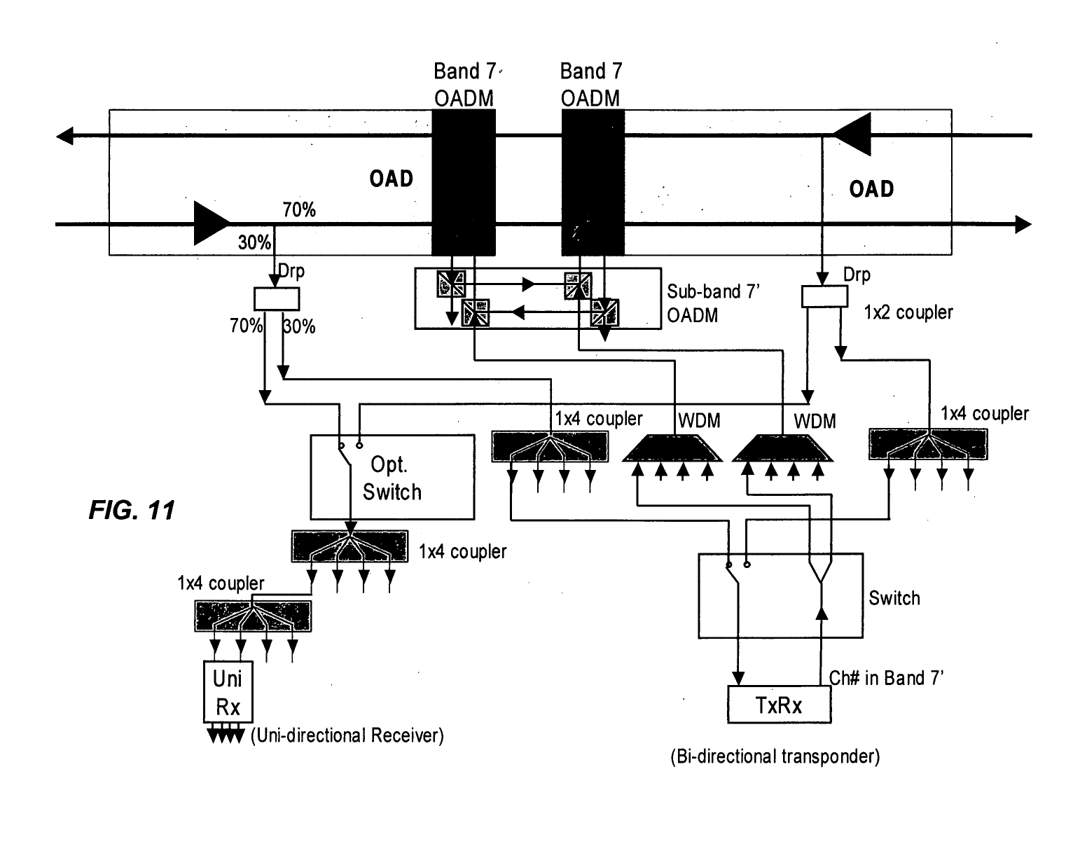

A more detailed design for the node 1020 is shown in FIG. 11 based on the design in FIG. 5. Alternatively, the node design in FIG. 6 may be modified to implement the node 1020. Hence, bands 1-6 and 7″ are allocated to the node 1010 and may be used to provide various uni-directional services such as delivering VOD signals to proper users.

The capability of assigning different channels within a common band to different nodes in FIG. 10 adds implementation flexibility and scalability in the ring network 1000. Allocation of different signal bands is pre-determined when designing the ring network 1000. Some hardware components in different nodes are specifically designed to drop, detect, and add signals at their respectively allocated bands. In FIG. 10. for example, optical components for dropping and adding light at the allocated band 8 are designed to operate at the wavelength or wavelengths of the band 8 and generally cannot operate properly to drop and add light at a different band, e.g., band 1. This feature of the ring networks (e.g., FIGS. 3 and 8) based on the design in FIG. 2 restricts subsequent changes or modifications to the ring networks. The splitting of a pre-assigned band into two or more different band channels allows the ring network 1000 to flexibly assign a band channel to a new node added to the ring. In the example shown in FIG. 10, only the hub 1010 needs a modification to add the new node 1020. Other nodes such as the node 1030 remains unchanged.

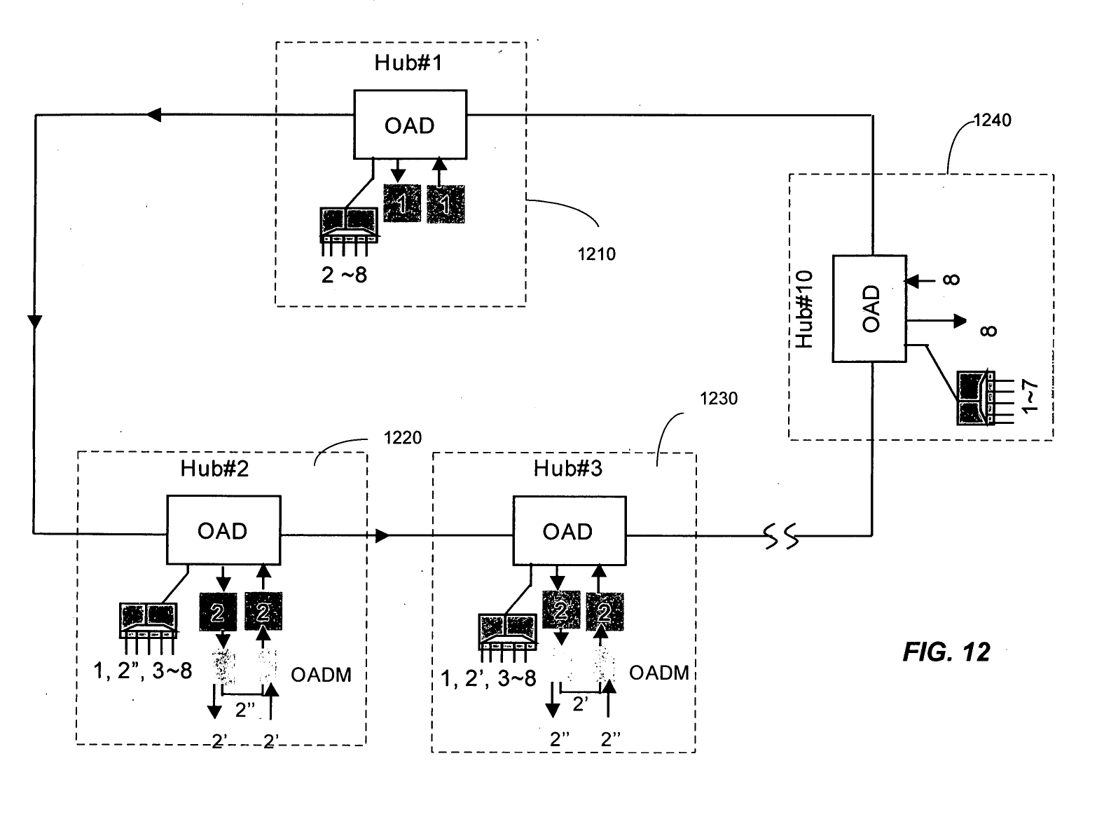

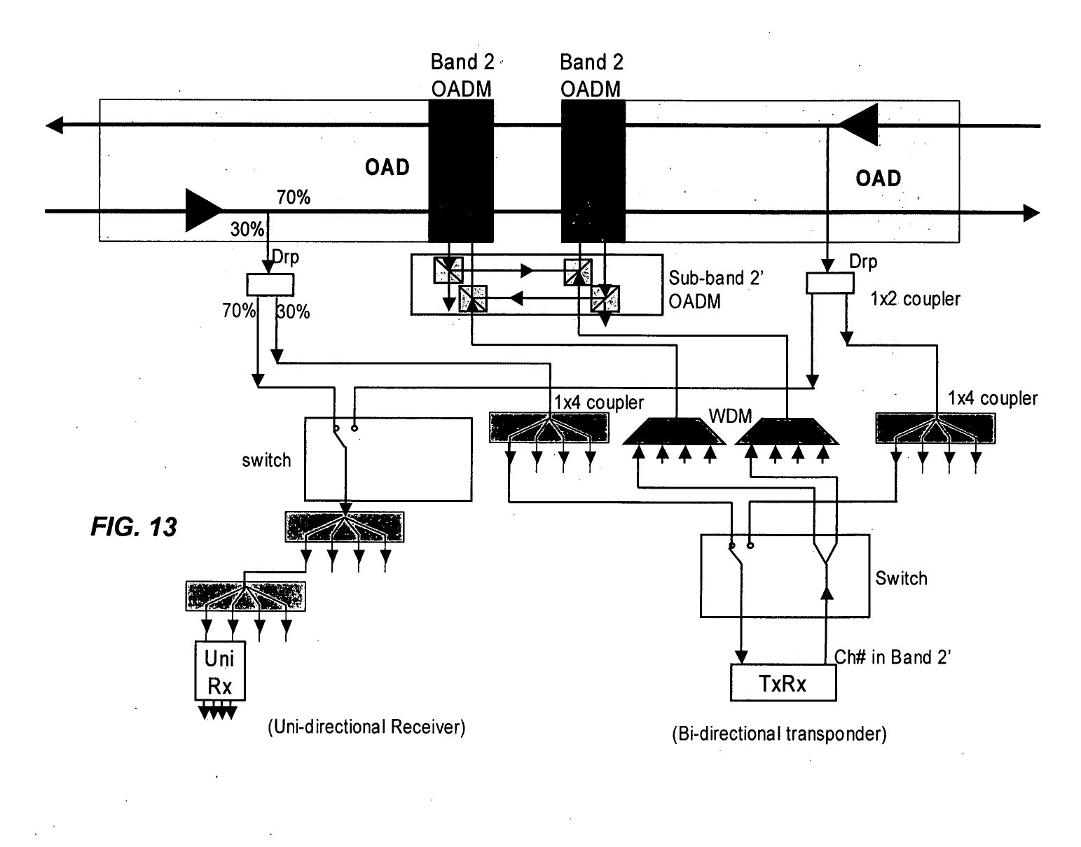

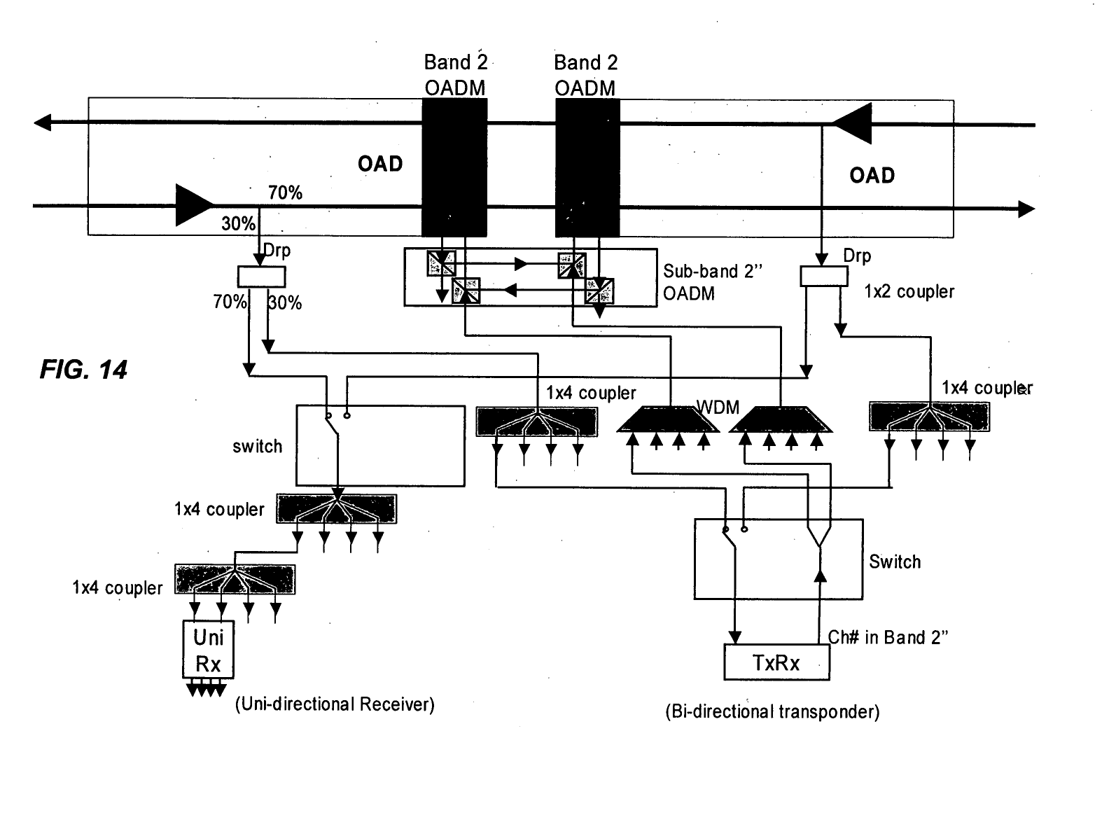

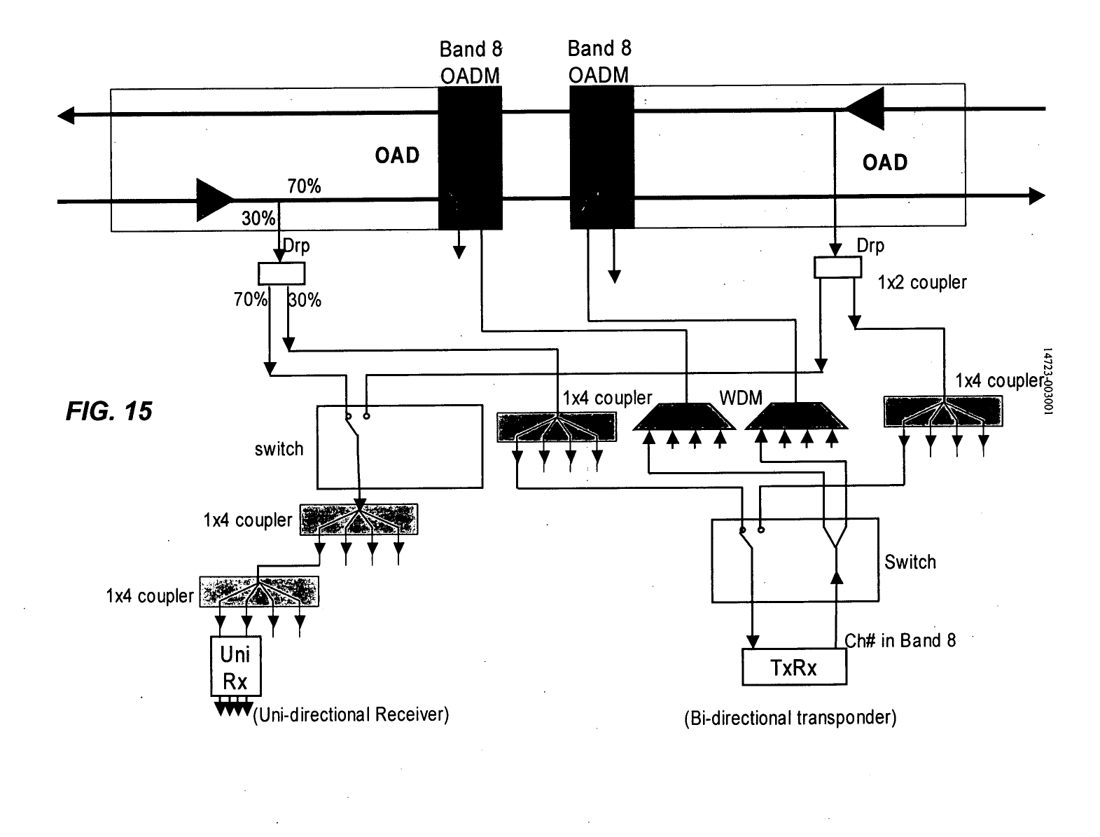

FIG. 12 shows a fourth example of a dual fiber ring network 1200 where two nodes 1220 and 1230 are allocated with two bands 2′ and 2″ within the same band 2, respectively. The node design shown in FIGS. 10 and 11 may be used to implement the nodes 1220 and 1230. Other nodes 1210 and 1240 may be implemented using the node designs in FIG. 5 or 6. FIGS. 13, 14, and 15 show examples of nodes 1220, 1230, and 1240, respectively, based on the node design in FIG. 5.

The above examples and exemplary implementations of dual fiber ring networks have a number of advantages. For example, fiber path failure protection can be provided to each bi-directional transmission between any two nodes. Such fiber path failure protection is performed within each node which provides both local detection and local switching operations. Therefore, any transmission is lost only for a short period, typically 50 ms or less, when fiber path failure occurs. As another example, any node can broadcast its information to any other node in optical domain uni-directionally. This is generally simple and easy to deploy. In the mean time, any node can receive information from any other node in optical domain. As yet another example, while suitable for symmetric node to node bi-directional communication, the above implementations may be particularly efficient in carrying highly asymmetric traffic signals, such as VOD applications in cable or other applications that need mass downloading information from storage servers. Furthermore, the above implementations of the ring networks can be easily scalable so that each ring can be expanded to add additional nodes as needed.

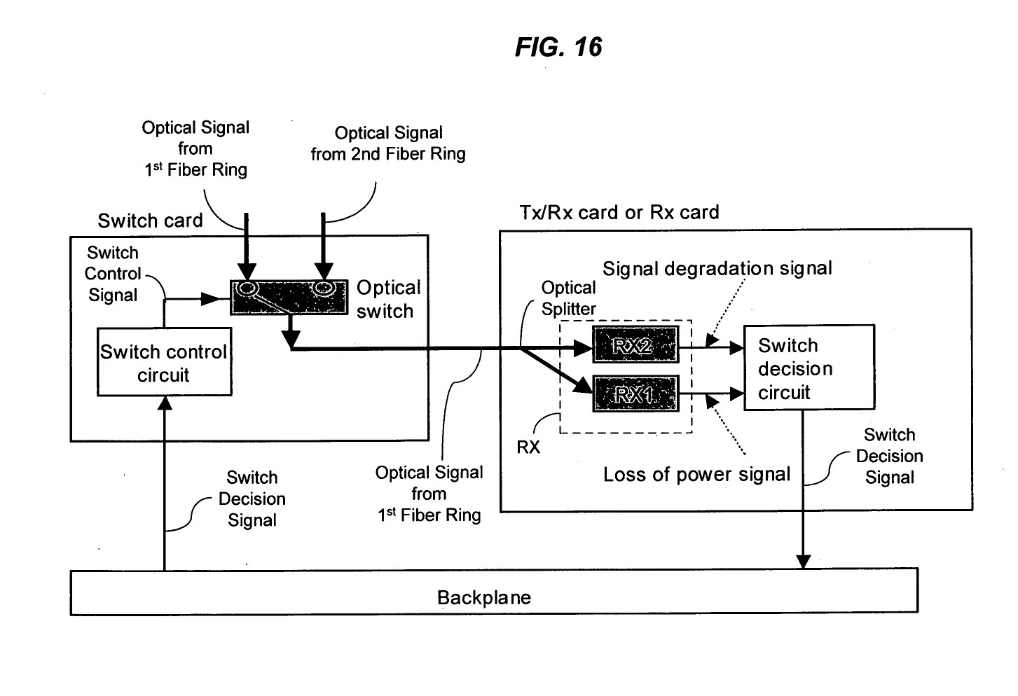

FIG. 16 shows one exemplary implementation of the local detection and local switch within a node in a dual fiber ring network described in FIG. 1. This design may be implemented in the dual fiber ring networks described in this application. In FIG. 16, the optical switch in the node is shown to be part of a switch card and is controlled by a switch control signal from a switch control circuit. The node further includes an optical receiver RX that receives the optical signal from the optical switch. The optical switch connects to receive optical signals from both fiber rings and switches only one optical signal to the optical receiver RX. A switch decision control circuit processes the output of the optical receiver RX to determine whether the optical signal from the optical switch is acceptable and generates a switch decision signal to the switch control circuit. The switch decision signal may be directed through the backplane in the node and hence both the detection and switch control are located within the node. The detection and switch control are local to each node because there is no communication outside the node for detecting the quality of the received optical signal and for switching the optical switch in case the signal becomes unacceptable. This local implementation allows for fast switching at or below 50 ms.

In the example shown in FIG. 16, the optical receiver RX is used to detector data in the received optical signal and to produce two different monitor signals by detecting the optical signal from the optical switch. First, the bit error rate in the received optical signal is detected to generate a signal degradation signal to indicate the level of the bit error rate in the optical signal from the optical switch. If the bit error rate is below a pre-determined threshold level and becomes unacceptable, the optical switch is controlled to send the optical signal from the other fiber ring to the optical receiver RX. Second, the power level of the received optical signal is monitored to produce a loss of power signal to indicate the whether the optical power level of the received optical signal is acceptable. When any one of the two indicators fails the acceptable level, the decision circuit uses the switch decision signal to inform the control circuit of this failure so that the optical switch is switched to another fiber ring.

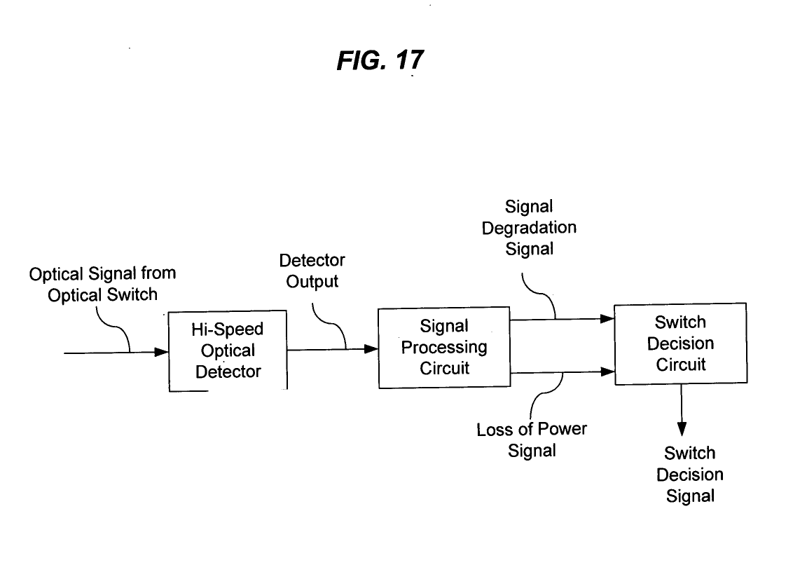

FIG. 16 shows that two optical detectors RX1 and RX2 may be used to implement the optical receiver RX by having an optical splitter or coupler to split the received optical signal into two separate optical signals to be detected by the two detectors RX1 and RX2, respectively. FIG. 17 show an alternative design where a single hi-speed optical detector is used for both data detection and the two monitoring functions. A signal processing circuit is used to process the detector output to produce the signal degradation signal and the loss of power signal for the switch decision circuit.

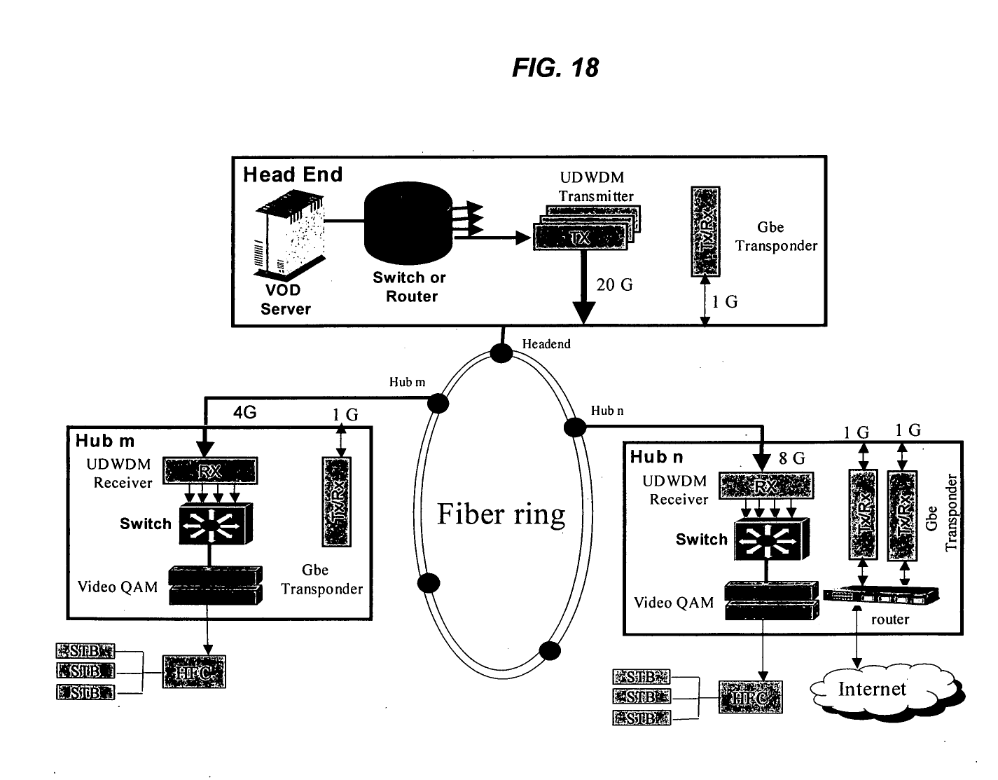

FIG. 18 further shows that a VOD system based on the dual fiber ring networks of this application to illustrate an implementation in an asymmetric traffic ring network where the data traffic is mainly from the headend to different hubs connected to VOD service consumers represented by setup boxes (STBs). In the illustrated example, the Ultra Dense WDM transmitters in headend are dedicated to delivery of VOD service. The video streams are transmitted by ultra dense WDM (UDWDM) optical transmitters (TXs) (e.g., at 20 Gb/s) from the headend to UDWDM optical receivers (RXs) in the hubs. Each UDWDM receiver may receive at a high speed, e.g., 4 Gb/s. The VOD service information, such as service request, service delivery and billing, are carried by gigabit Ethernet (Gbe) transponder, as illustrated in the FIG. 18. Beyond those VOD service data, other type of data and voice information can be communicated in between any two nodes by Gbe transponder. In the illustrated example, the headend is dedicated to be VOD service center and one of the hubs (hub n) is used to be data service center for the ring (e.g., Internet access and other data services). In this design, the hub n has two Gbe transponders, one in communication with the Gbe transponder in the headend for Data, voice, and the VOD service to the customers connected to the hub n and another in communication with the Gbe transponder in another hub m for delivering data services between hub m and hub n. Alternatively, the data services center may be implemented in the headend.

In implementing the above ring networks, each node may be equipped with a broadband coupler to receive uni-directionally broadcast traffic from any other nodes, and one or a pair of channel OADs or band OADs to add traffic. Also, each node may be equipped with a narrowband filter to receive uni-directional traffic from a certain number of other nodes, and a pair of channel OADs or band OADs to drop and add bi-directional traffic.

The above ring networks may be designed to accommodate a range of available optical wavelengths for carrying data channels. A part of such wavelengths may be allocated for uni-directional applications while some others may be allocated for bi-directional applications.

Such a ring network may be configured as a centralized optical network with multi-channel multiplexers and demultiplexers located at the central location. One example of the central location is a headend in CATV network). The majority of the traffic is emitted from this central location. Not only the uni-directional traffic from this central location to other dispersed hubs is protected, but also the bi-directional traffic from hub to hub and from hub to the central location is protected.

In the case of hub-to-hub traffic protection at specific wavelengths or bands, optical bypass in the central location only at those wavelengths or bands is executed. The local traffic at each hub can be added to the ring network via a broadband coupler or an (channel or band) OAD, while it has to be stripped off from the ring network after circulating around the ring once by using a similar OAD.

The above ring networks may also be configured as a distributed optical network with channel or band OADs located at each hub. All hubs can generate uni- and bi-directional traffic into the ring network. Uni-directional traffic generated from a hub is received by all other hubs on the ring network (broadcast), while bi-directional traffic is received only by a designated hub. Uni-directional traffic originated from a hub needs to be stripped off the ring network after it circulates around the ring network once.

All the above network implementations may utilize O-UPSR or tail-end optical switching to achieve a short recovery time, e.g., less than 50 ms.

Only a few implementations and examples are disclosed. However, it is understood that variations and enhancements may be made.

1. An optical ring network system, comprising:
a plurality of communication nodes;
a first fiber ring coupled to said communication nodes to direct WDM optical signals at different wavelengths; and
a second fiber ring coupled to said communication nodes to direct duplication of said WDM optical signals,
wherein each communication node that sends a signal is operable to add and drop at least one pre-selected WDM optical signal in both said first and second fiber rings without an optical break point in other communication nodes, and further allows for other WDM optical signals to get dropped and to continue to a next communication node without changing information therein,
wherein each communication node comprises an optical receiver, an optical switch to direct light from said first fiber ring into said optical receiver, and a switch control which monitors light received by said optical receiver and control said optical switch to direct light from said second fiber ring to said optical receiver when a signal property in light from said first fiber ring fails to meet a threshold.

2. The system as in claim 1, wherein two or more adjacent WDM optical signals of said WDM optical signals are within one ITU grid.

3. The system as in claim 1, wherein said WDM optical signals are subcarrier signals by subcarrier multiplexing via optical single sideband modulation.

4. The system as in claim 1, wherein a communication node that sends a signal provides a single optical break point in said first and said second fiber rings for a designated band of a plurality of WDM optical signals.

5. The system as in claim 4, wherein the communication node uses one WDM optical signal within the designated band to provide uni-directional communication with another communication node.

6. The system as in claim 4, wherein the communication node uses one WDM optical signal within the designated band to provide bi-directional communication with another communication node.

7. The system as in claim 6, wherein the communication node uses another WDM optical signal within the designated band to provide bi-directional communication with a third communication node.

8. The system as in claim 4, wherein the communication node uses one WDM optical signal within the designated band to broadcast to other communication nodes.

9. The system as in claim 1, wherein the signal property is a bit error rate detected at the optical receiver.

10. The system as in claim 1, wherein the signal property is a power level measured at the optical receiver.

11. The system as in claim 1, wherein each communication node comprises a mechanism to select one or more WDM optical signals in said first and said second fiber rings to extract information.

12. A method, comprising:
providing first and second fiber rings that are optically coupled to a plurality of communication nodes;
coupling each optical signal from a communication node to both the first and the second fiber rings;
using a single communication node to originate and terminate one or more pre-selected optical channels in the first and the second fiber rings without having an optical break point in the one or more pre-selected optical channels in other communication nodes, and to pass through other optical channels without changing information therein;
using an optical receiver within each communication node to monitor a signal quality in light from the first fiber ring via an optical switch within each communication node to receive light from both the first and the second fiber rings; and
controlling the optical switch to direct light from the second fiber ring into the optical receiver when the signal quality from the first fiber ring fails to meet a threshold.

13. The method as in claim 12, further comprising configuring one communication node to passively receive light from the first and the second fiber rings without sending a signal.

14. The method as in claim 12, further comprising using a communication node which originates and terminates a pre-selected optical channel to send unidirectional communication in the pre-selected optical channel to at least one other communication node.

15. The method as in claim 12, further comprising using a communication node which originates and terminates a pre-selected optical channel to send unidirectional communication to a second communication node and to receive unidirectional communication in a second selected optical channel originated and terminated at the second communication node to establish bidirectional communication with the second communication node.

16. An optical ring network system, comprising:
a plurality of communication nodes;
a first fiber ring coupled to said communication nodes to direct WDM optical signals at different wavelengths along a first direction; and
a second fiber ring coupled to said communication nodes to direct duplication of said WDM optical signals along a second direction opposite to said first direction,
wherein a first communication node is operable to add and drop a first WDM optical signal in both said first and second fiber rings, and said first communication node further allows for other WDM optical signals to get dropped and to continue to a next communication node without changing information therein,
wherein a second communication node adds and drops a second WDM optical signal in both said first and second fiber rings, and said second communication node further allows for other WDM optical signals to get dropped and to continue to a next communication node without changing information therein, and
wherein each of other communication nodes allows for said first and said second WDM optical signals to get dropped and to continue to a next communication node without changing information therein.

17. The system as in claim 16, wherein a communication node includes a broadband coupler to receive uni-directionally broadcast traffic from any other nodes.

18. The system as in claim 16, wherein a communication node includes a pair of channel optical add drop devices respectively coupled to said first and said second fiber rings to add and drop a channel for bi-directional traffic.

19. The system as in claim 16, wherein a communication node includes a pair of band optical add drop devices respectively coupled to said first and said second fiber rings to drop and add a plurality of optical channels within a band for bi-directional traffic.

20. The system as in claim 16, wherein a communication node includes a narrowband optical coupler to receive uni-directional traffic from a certain number of other communication nodes.

21. The system as in claim 20, wherein said communication node further includes a pair of channel optical add and drop devices or band optical add and drop devices to drop and add signals of bi-directional traffic.

22. The system as in claim 16, wherein a first portion of available optical wavelengths are allocated for carrying uni-directional communication traffic and a second portion of said available optical wavelengths are allocated for bi-directional communication traffic.

23. The system as in claim 16, wherein said communication nodes are configured to form a centralized optical network, wherein a first communication node is configured to include multi-channel multiplexers and demultiplexers to produce and send out a majority of communication traffic.

24. The system as in claim 23, wherein said first communication node is a headend node in a CATV system.

25. The system as in claim 23, further including a protection mechanism to protect the uni-directional traffic from said first communication node to other communication nodes.

26. The system as in claim 23, further comprising a protection mechanism to protect the bi-directional traffic between any two communication nodes.

27. The system as in claim 16, wherein said communication nodes are configured to form a distributed communication network, wherein each communication node includes channel or band optical add drop devices to produce uni-directional and bi-directional traffic to the network.

28. The system as in claim 16, wherein each communication node includes an optical switching mechanism to switch communication with said first fiber ring to said second fiber ring when a failure is detected in said first fiber ring.

29. The system as in claim 16, wherein each communication node includes an optical uni-directional path switching mechanism to switch communication from one fiber ring to another fiber ring.
